(19) United States
(12) Patent Application Publication
(10) Pub. No.: US 2017/0277679 A1
(43) Pub. Date: Sep. 28, 2017

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Yasunari Miyabe, Kawasaki Kanagawa (JP); Kazuyuki Goto, Kawasaki Kanagawa (JP); Kenta Cho, Kawasaki Kanagawa (JP); Masahisa Shinozaki, Tokorozawa Saitama (JP); Keisuke Sakanushi, Mitaka Tokyo (JP); Guowei Zu, Inagi Tokyo (JP); Kaoru Hirano, Kunitachi Tokyo (JP)

(21) Appl. No.: 15/456,843

(22) Filed: Mar. 13, 2017

(30) Foreign Application Priority Data
Mar. 23, 2016 (JP) 2016-058258

(51) Int. Cl. G06F 17/27; G06F 17/28; G10L 15/26

(52) U.S. Cl. CPC G06F 17/2785; G10L 15/26; G06F 17/2863; G06F 17/274

(57) ABSTRACT

An information processing device includes an extracting unit, a first calculating unit, and a second calculating unit. From a sentence included in a set of sentences, the extracting unit extracts compound words, each made of a plurality of words, and first words other than the words constituting the compound words. The first calculating unit calculates, based on the occurrence frequencies of the first words and based on the occurrence frequencies of the compound words, first degrees of importance indicating the degrees of importance of the first words and the degrees of importance of the compound words. With respect to first sentences included in the set of sentences, the second calculating unit calculates second degrees of importance, which indicate the degrees of importance of the first sentences, based on the first degrees of importance of the words and the first degrees of importance of the compound words.

### CROSS-REFERENCE TO RELATED APPLICATIONS

This application is based upon and claims the benefit of priority from Japanese Patent Application No. 2016-058258, filed on Mar. 23, 2016; the entire contents of which are incorporated herein by reference.

### FIELD

Embodiments described herein relate generally to an information processing device, an information processing method, and a computer program product.

### BACKGROUND

Accompanying the development of information systems in recent years, it has become possible to store written documents such as patent literature, newspaper articles, webpages, and books as well as to store media data such as videos and audios. There is a demand for a technology that enables easy understanding of the brief overview or the concise summary from such stored media data.

As one of such technologies, a technology has been proposed in which key sentences are selected by combining the frequency of words and the degree of importance of user-selected keywords.

### BRIEF DESCRIPTION OF THE DRAWINGS

FIG. 1 is a block diagram illustrating an exemplary functional configuration of a system including an information processing device according to a first embodiment;

FIG. 2 is a diagram illustrating an example of sentences stored in a memory device;

FIG. 3 is a flowchart for explaining an example of a degree-of-importance display operation performed according to the first embodiment;

FIG. 4 is a diagram for explaining a specific example of a speech input operation and a speech recognition operation;

FIG. 5 is a flowchart for explaining an example of an extraction/calculation operation performed according to the first embodiment;

FIG. 6 is a flowchart for explaining an example of a degree-of-importance calculation operation performed according to the first embodiment;

FIG. 7 is a diagram illustrating an example of an output operation for outputting key sentences;

FIG. 8 is a block diagram illustrating an exemplary functional configuration of a system including an information processing device according to a second embodiment;

FIG. 9 is a diagram illustrating an exemplary data structure of filler conversion rules;

FIG. 10 is a flowchart for explaining an example of a degree-of-importance display operation performed according to the second embodiment;

FIG. 11 is a flowchart for explaining an example of a filler conversion operation;

FIG. 12 is a diagram illustrating another example of sentences stored in the memory device;

FIG. 13 is a block diagram illustrating an exemplary functional configuration of a system including an information processing device according to a third embodiment;

FIG. 14 is a flowchart for explaining an example of a degree-of-importance display operation performed according to the third embodiment;

FIG. 15 is a flowchart for explaining an example of a calculation operation;

FIG. 16 is a flowchart for explaining an example of a calculation operation;

FIG. 17 is a diagram illustrating an example of an output operation for outputting key sentences;

FIG. 18 is a block diagram illustrating an exemplary functional configuration of a system including an information processing device according to a fourth embodiment;

FIG. 19 is a diagram illustrating an exemplary data structure of a dictionary; and

FIG. 20 is an explanatory diagram illustrating an exemplary hardware configuration of the information processing device according to the first to fourth embodiments.

### DETAILED DESCRIPTION

According to one embodiment, an information processing device includes an extracting unit, a first calculating unit, and a second calculating unit. From a sentence included in a set of sentences, the extracting unit extracts compound words, each made of a plurality of words, and first words other than the words constituting the compound words. The first calculating unit calculates, based on the occurrence frequencies of the first words and based on the occurrence frequencies of the compound words, first degrees of importance indicating the degrees of importance of the first words and the degrees of importance of the compound words. With respect to first sentences included in the set of sentences, the second calculating unit calculates second degrees of importance, which indicate the degrees of importance of the first sentences, based on the first degrees of importance of the words and the first degrees of importance of the compound words.

Exemplary embodiments of an information processing device according to the invention are described below in detail.

### First Embodiment

As described above, there is a demand for a technology that enables easy understanding of the brief overview from stored media data. For example, there are demands as follows.
In a team meeting, the utterances of the members are subjected to speech recognition and, from the text obtained as the recognition result, the details of the meeting are understood in a short amount of time.
In a contact center, the inquiries from the customers are subjected to speech recognition, and, from the text obtained as the recognition result, details of the inquiries are understood and an after-call report is created.

An information processing device according to a first embodiment calculates the degree of importance of a sentence by not only taking into account the degrees of importance of words but also taking into account the degrees of importance of compound words. Herein, a compound word represents a word made of a plurality of words. Because of the constituent words thereof, a compound word often makes the meaning of the sentence clearer, and is often the key term expressing the topic. Conversely, if a word that is not a compound word expresses the topic, the person who is speaking or writing is not supposed to use compound words but is supposed to frequently use words that are not component words. In the first embodiment, as a result of taking into account the degrees of importance of compound words, the degrees of importance of the sentences can be calculated with a higher degree of accuracy. As a result, from a set of utterances that have been subject to speech recognition or from a set of texts, the key sentences can be selected with a higher degree of accuracy.

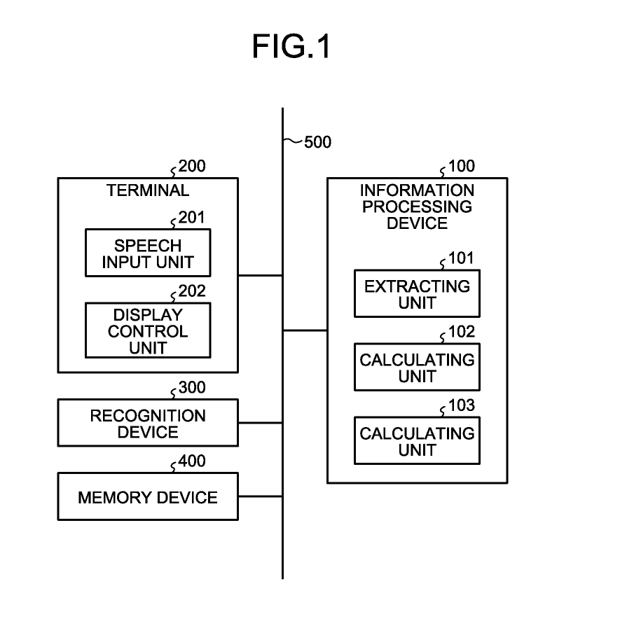

FIG. 1 is a block diagram illustrating an exemplary functional configuration of a system including the information processing device according to the first embodiment. In the system according to the first embodiment; an information processing device 100, a terminal 200, a recognition device 300, and a memory device 400 are connected to each other via a network 500.

Examples of the network 500 include a local area network (LAN) and the Internet. However, the network 500 is not limited to those examples, and can have an arbitrary network form.

The terminal 200 is a terminal device such as a smartphone, a tablet, or a personal computer (PC) used by the user. The terminal 200 includes a speech input unit 201 and a display control unit 202.

The speech input unit 201 receives input of the speech uttered by the user. The display control unit 202 controls the display processing with respect to a display device such as a display. For example, the display control unit 202 displays the speech recognition result obtained by the recognition device 300, and displays the selected key sentences.

The recognition device 300 performs speech recognition and outputs a text indicating the recognition result. For example, the recognition device 300 performs speech recognition with respect to the speech input by the user via the speech input unit 201, converts the recognition result into a text, and stores the text on a sentence-by-sentence basis in the memory device 400.

The memory device 400 includes a memory unit for storing a variety of information and can be configured using any commonly-used memory medium such as a hard disk drive (HDD), an optical disk, a memory card, or a random access memory (RAM).

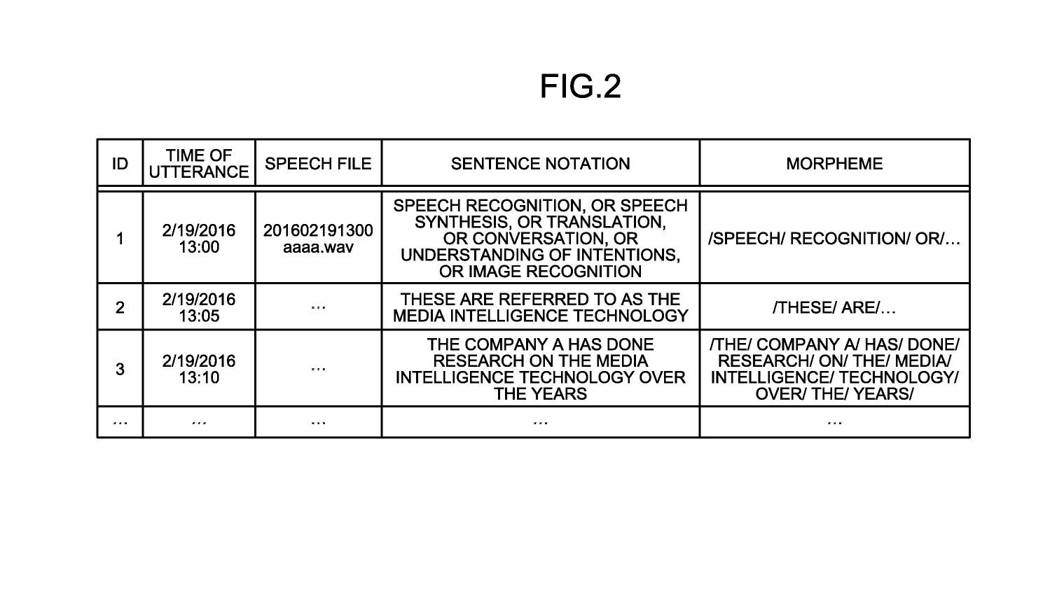

The memory device 400 is used to store, for example, the sentences representing the result of speech recognition performed by the recognition device with respect to the speech input by the user via the speech input unit 201. FIG. 2 is a diagram illustrating an example of the sentences (text data) stored in the memory device 400.

As illustrated in FIG. 2, the text data contains the following items: ID, time of utterance, speech file, sentence notation, and morpheme. The item “ID” represents information enabling identification of the text data. The item “time of utterance” represents the timing of input of the speech. The item “speech file” represents information (such as a path or a file name) specifying the file that is stored after recording the speech therein. The item “sentence notation” represents the result of speech recognition. The item “morpheme” represents the result of dividing the text (the sentence notation), which is obtained by speech recognition, in the units of morphemes. In FIG. 2, a symbol “/” represents the separation of morphemes. Meanwhile, alternatively, the morphemes need not be stored. Instead, for example, during the processing performed by the information processing device 100, morphological analysis can be performed with respect to each sentence.

Returning to the explanation with reference to FIG. 1, the information processing device 100 calculates the degree of importance of each sentence included in a set of sentences. The degrees of importance of sentences are useful in selecting key sentences from the sentences included in a set of sentences. As long as a set of sentences includes a plurality of sentences, it can be of any type. For example, a set of sentences can be the set of sentences recognized by the recognition device 300 and stored in the memory device 400. Meanwhile, a set of sentences need not represent the result of speech recognition, and can alternatively be a set of written documents retrieved from a webpage, or a set of media data, or a combination of such sets.

The configuration illustrated in FIG. 1 is only exemplary, and it is not the only possible configuration. That is, at least some functions of a particular device can be included in another device, or the functions of a plurality of devices can be included in a single device. For example, the function of the memory device 400 (i.e., the function of storing information) can be included in at least one of the recognition device 300 and the information processing device 100. Alternatively, for example, some or all of the functions of the recognition device 300, the memory device 400, and the information processing device 100 can be included in a single device.

Given below is the detailed explanation of the functional configuration of the information processing device 100. As illustrated in FIG. 1, the information processing device 100 includes an extracting unit 101, a calculating unit 102 (a first calculating unit), and a calculating unit 103 (a second calculating unit).

The extracting unit 101 extracts, from the sentences included in a set of sentence, compound words and words (first words) other than the words constituting the compound words. For example, from each sentence stored in the memory device 400, the extracting unit 101 extracts words and compound words.

The calculating unit 102 calculates the degrees of importance (first degrees of importance) of the extracted words and the extracted compound words. For example, based on the occurrence frequencies of the extracted words and based on the occurrence frequencies of the extracted compound words, the calculating unit 102 calculates the degrees of importance of the extracted words and the degrees of importance of the extracted compound words. Then, based on the occurrence frequencies of the extracted words, based on the occurrence frequencies of the extracted compound words, and based on concatenation frequencies indicating the frequencies at which the words constituting compound words are connected to other words; the calculating unit 102 can calculate the degrees of importance of the extracted words and the degrees of importance of the extracted compound words.

The calculating unit 103 calculates the degree of importance of each sentence (a first sentence) included in a set of sentences. For example, with respect to each sentence included in a set of sentences, the calculating unit 103 calculates a score indicating the degree of importance (a second degree of importance) of that sentence based on the degrees of importance calculated for the words and the compound words included in that sentence.

Meanwhile, the constituent elements of the terminal 200 and the information processing device 100 (i.e., the speech input unit 201, the display control unit 202, the extracting unit 101, the calculating unit 102, and the calculating unit 103) can be implemented by making one or more processors such as a central processing unit (CPU) to execute computer programs, that is, can be implemented using software; or can be implemented using hardware such as one or more integrated circuits (IC); or can be implemented using a combination of software and hardware.

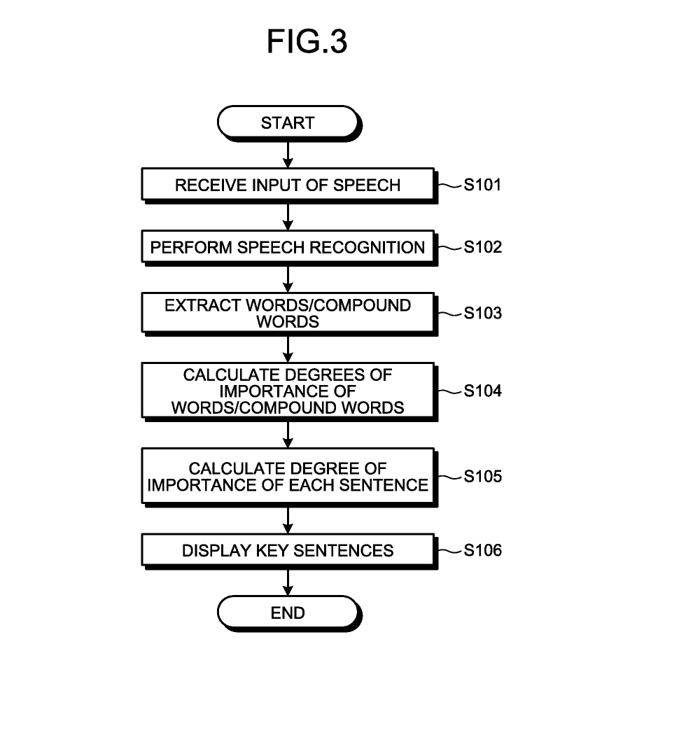

Explained below with reference to FIG. 3 is a degree-of-importance display operation performed by the information processing device 100 configured in the abovementioned manner according to the first embodiment. FIG. 3 is a flowchart for explaining an example of the degree-of-importance display operation performed according to the first embodiment.

The speech input unit 201 of the terminal 200 receives input of the speech uttered by a user (Step S101). The recognition device 300 performs speech recognition with respect to the input speech, and stores the text obtained as a result of speech recognition in the memory device 400 on a sentence-by-sentence basis (Step S102). As far as the speech recognition method is concerned, any arbitrary method can be implemented. Also regarding the method for dividing a text into sentences, any arbitrary method can be implemented. For example, if the length of a silent section exceeds a threshold value, it can be determined to be the separation between sentences, and division into sentences can be performed. Meanwhile, the operation of dividing a text into sentences can be performed along with the speech recognition operation. Moreover, the input speech can be recorded so as to make it available for confirmation at a later timing.

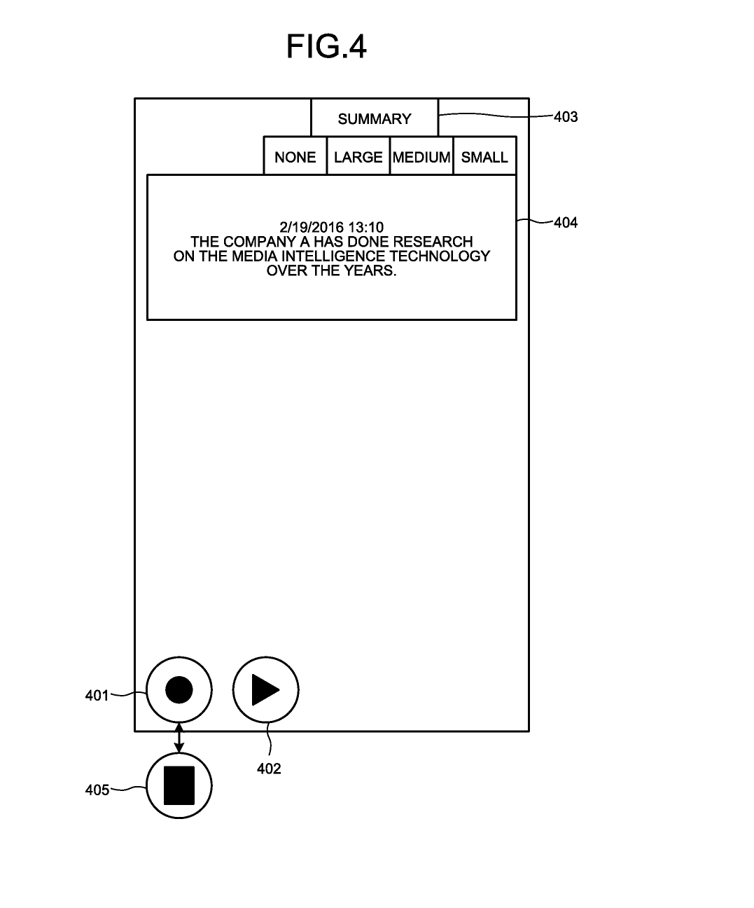

FIG. 4 is a diagram for explaining a specific example of the speech input operation performed at Step S101 and the speech recognition operation performed at Step S102. In FIG. 4 is illustrated a display screen for displaying the text obtained by performing speech recognition with respect to the speech input by a user, and for displaying the selected key sentences. The display screen includes a recording start button 401, an audio playback button 402, a display control button 403, and a display area 404.

For example, after pressing the recording start button 401, the user starts inputting the speech. The input speech is then sent to the recognition device 300 and is subjected to speech recognition therein. The result of speech recognition is stored in the memory device 400. The display area 404 is used to display the obtained recognition result. Meanwhile, when the recording start button 401 is pressed, the recording start button 401 is changed to a recording end button 405. Until the recording end button 405 is pressed, speech recognition and audio recording is performed with respect to the input speech.

Returning to the explanation with reference to FIG. 3, after the operation at Step S102 is completed, the information processing device 100 performs the degree-of-importance display operation with respect to the set of sentences (Steps S103 to S106). Firstly, the extracting unit 101 extracts, from the set of sentences, compound words and words other than the words constituting the compound words (Step S103). The calculating unit 102 calculates the degrees of importance of the extracted words and the extracted compound words (Step S104). Moreover, based on the calculated degrees of importance, the calculating unit 103 calculates the degree of importance of each sentence (Step S105). Regarding the operations performed at Steps S103 to S105, the detailed explanation is given later.

The display control unit 202 of the terminal 200 refers to the degree of importance of each sentence, and selects and displays the sentences in order of importance (Step S106). For example, the display control unit 202 extracts a predetermined number of sentences in descending order of the degrees of importance as key sentences, arranges the extracted key sentences in order of time of utterance, and displays them on the display device.

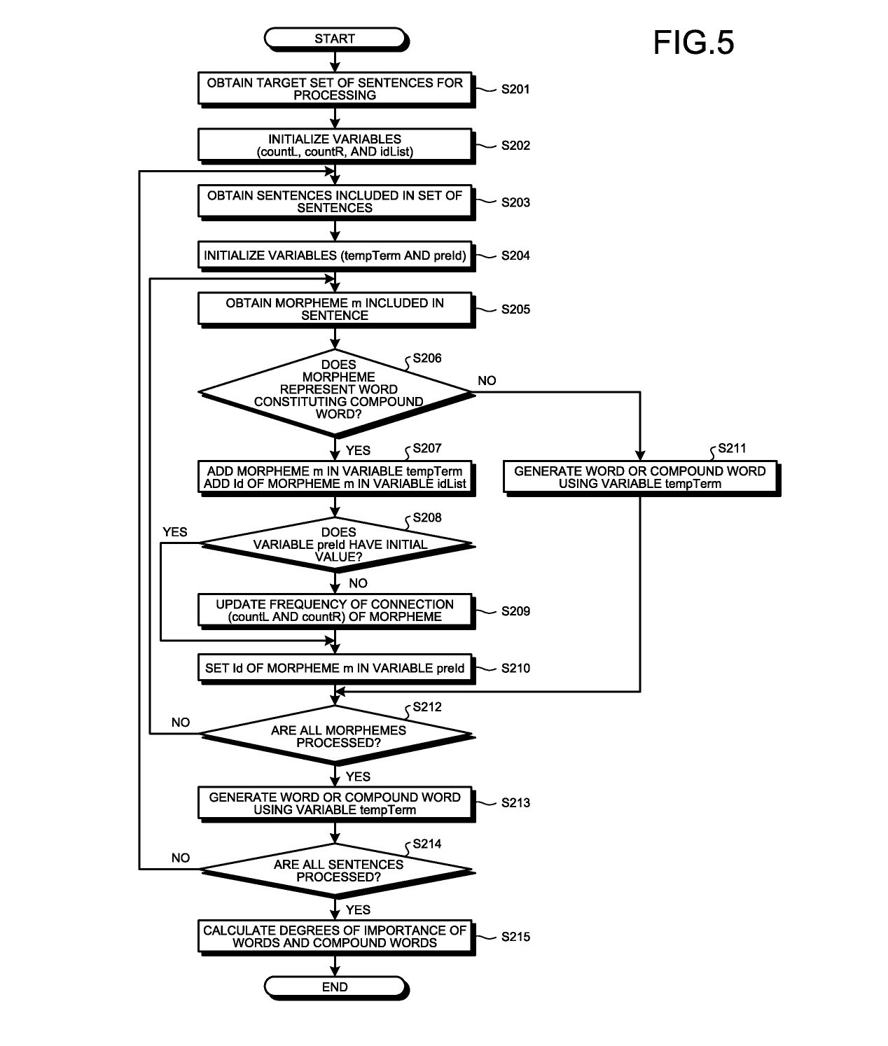

Given below is the detailed explanation of the extraction/calculation operation performed at Steps S103 and S104. FIG. 5 is a flowchart for explaining an example of the extraction/calculation operation performed according to the first embodiment.

The extracting unit 101 extracts the set of sentences from which key sentences are to be selected (Step S201). Herein, for example, the set of sentences either can be the set of all sentences stored in the memory device 400, or can be the set of such sentences, from among the set of stored sentences, which are uttered on a particular date and time. Regarding the particular date; beginning at the year, the month, and the day on which the user activates the terminal 200, the particular date can be the same year as the year of activation, or the same month as the month of activation, or the same day as the day of activation. Herein, a particular day or a particular time of a particular day can be made specifiable from the terminal 200.

The extracting unit 101 initializes each variable used in the calculations (Step S202). For example, the extracting unit 101 initializes a variable countL(x), a variable countR(x), and a variable idList. The variable countL(x) holds the left-side concatenation frequency of a word constituting a compound word. The variable countR(x) holds the right-side concatenation frequency of a word constituting a compound word. Herein, “x” represents identification information (Id) of a word. That is, the left-side concatenation frequency and the right-side concatenation frequency are held on a word-by-word basis. The variable idList holds a list of identification information (Id) of the words (morphemes) constituting compound words.

The extracting unit 101 obtains an unprocessed sentence from a set of sentences (Step S203). Moreover, the extracting unit 101 initializes each variable to be used in the processing of each sentence (Step S204). For example, the extracting unit 101 initializes a variable tempTerm and a variable preId. The variable tempTerm holds the character string of a word or a compound word that is generated. The variable preId represents identification information of the previous word or the previous compound word of the target morpheme for processing.

The extracting unit 101 obtains a morpheme m from among the unprocessed morphemes included in the obtained sentence (Step S205). Then, the extracting unit 101 determines whether or not the morpheme m is a word constituting a compound word (Step S206). For example, the extracting unit 101 takes into account the part of speech and the character type, and determines whether or not the morpheme m is a word constituting a compound word.

In the case of using the part of speech, for example, if the part of speech is “noun”, then the extracting unit 101 determines that the morpheme m is a word constituting a compound word. If the part of speech is a self-sufficient word such as “noun”, “verb”, or “adjective”, then the extracting unit 101 can determine that the morpheme m is a word constituting a compound word. In the case of using the character type, for example, if the character type is “characters including kanji characters, katakana characters, and alphabets”, the extracting unit 101 determines that the morpheme m is a word constituting a compound word.

If the morpheme m is a word constituting a compound word (Yes at Step S206), then the extracting unit 101 adds the character string of the morpheme m in the variable tempTerm and adds the identification information (Id) of the morpheme m in the variable idList (Step S207). The extracting unit 101 determines whether or not the variable preId has the initial value (Step S208). If the variable preId does not have the initial value (No at Step S208), then the extracting unit 101 updates the concatenation frequency of the morpheme (Step S209). For example, the extracting unit 101 increments, by one, the variable countL (Id of morpheme m) and the variable countR (preId). Then, the extracting unit 101 substitutes the identification information (Id) of the morpheme m in the variable preId (Step S210).

Meanwhile, if the variable preId has the initial value (Yes at Step S208), the extracting unit 101 skips the operation at Step S209 and performs the operation only at Step S210. The case in which the variable preId does not have the initial value is a case in which two or more words constituting a compound word are in succession and connected. In that case, on the right-hand side of the character string of the variable preId, the morpheme m is connected. Conversely, on the left-hand side of the morpheme m, the character string of the variable preId is connected. Thus, the extracting unit increments, by one, the variable countL (Id of morpheme m) of the left-side concatenation frequency corresponding to the identification information (Id) of the morpheme m; and increments, by one, the variable countR (preId) of the right-side concatenation frequency corresponding to the variable preId.

At Step S206, if the morpheme m is not a word constituting a compound word (No at Step S206), then the extracting unit 101 generates, as a word or a compound word, the character string indicated by the variable tempTerm at that point of time (Step S211). For example, if a single set of identification information (Id) is included in the variable idList, the extracting unit 101 generates the word indicated by that identification information (Id). If two or more sets of identification information (Id) are included in the variable idList, then the extracting unit 101 generates a compound word made of the words indicated by those sets of identification information (Id). In this way, if two or more sets of identification information (Id) are included in the variable idList at that point of time, a compound word is formed. However, if a single set of identification information (Id) is included in the variable idList at that point of time, only a word is formed. Herein, depending on the length of the character string indicated by the variable tempTerm, the extracting unit 101 determines whether or not to generate a word or a compound word. For example, when the length of a character string is empty and when the character string has one character or less, the extracting unit 101 does not generate a word or a compound word.

At the time of generating a word or a compound word, the extracting unit 101 holds the identification information (Id) of the sentence to which the word or the compound word belongs. Moreover, after generating a word or a compound word, the extracting unit 101 initializes the variable tempTerm and the variable preId.

After performing the operation at Step S210 or Step S211, the extracting unit 101 determines whether or not all morphemes have been processed (Step S212). If all morphemes are not yet processed (No at Step S212), then the system control returns to Step S205, and the extracting unit 101 obtains the next morpheme and repeats the subsequent operations.

When all morphemes are processed (Yes at Step S212), in an identical manner to Step S211, the extracting unit 101 generates, as a word or a compound word, the character string indicated by the variable tempTerm at that point of time (Step S213).

Subsequently, the extracting unit 101 determines whether or not all sentences have been processed (Step S214). If all sentences are not yet processed (No at Step S214), then the system control returns to Step S203, and the extracting unit 101 obtains the next sentence and repeats the subsequent operations.

When all sentences are processed (Yes at Step S214), the calculating unit 102 calculates the degrees of importance of the generated words and the generated compound words (Step S215). For example, the calculating unit 102 calculates, as the degree of importance of a word or a compound word, a score FLR obtained according to Equation (1) or Equation (2) given below.

$$\begin{matrix}LR ( {N}_{1} {N}_{2} … {N}_{L} ) = ( {\prod }_{i = l}^{L} ( FL ( {N}_{i} ) + 1 ) \times {( FR ( {N}_{i} ) + 1 )}^{\frac{l}{2 L}} & ( 1 ) \\ FLR ( t ) = ( log ( LR ( t ) ) + 1 ) \times freq ( t ) & ( 2 )\end{matrix}$$

Meanwhile, Equation (1) is similar to Equation (3) mentioned in Non-patent Literature 1. According to Equation (1), a score LR for a compound word “N₁N₂ . . . N_{L}” is calculated. Herein, “Nᵢ” represents a word constituting the compound word (where, 1≦i≦L holds true, and L represents the number of words constituting the compound word).

When there is only a single constituent word, the score is calculated for that word. Herein, FL(Ni) represents the left-side concatenation frequency of the word Ni, and FR(Ni) represents the right-side concatenation frequency of the word Ni. In the example illustrated in FIG. 5, the variables countL(x) and countR(x) are equivalent to FL(Ni) and FR(Ni), respectively, of the word Ni having “x” as the identification information Id. The reason for incrementing FL and FR by one is to avoid the score LR from becoming equal to zero in response to either the left-side concatenation frequency or the right-side concatenation frequency becoming equal to zero. Thus, in Equation (1), the geometric mean of the left-side concatenation frequency and the right-side concatenation frequency of all words constituting a compound word represents the score. Meanwhile, although FL and FR are considered as the frequencies, they can be considered as the type counts of words.

Equation (2) represents the score indicating the degree of importance of a word t or a compound word t. The score in Equation (2) is calculated by multiplying freq(t) to the value that is obtained by performing a log operation with respect to the score LR obtained in Equation (1) and then adding one to that result of the log operation. Herein, freq(t) represents the frequency of independent appearances of the word or the compound word. An independent appearance implies an appearance without being included in another word or another compound word. Meanwhile, instead of performing a log operation with respect to the score LR and adding one to that result as given in Equation (2), the score FLR can be calculated as given below in Equation (3). Herein, Equation (3) is similar to Equation (4) mentioned in Non-patent Literature 1.

FLR(t)=LR(t)×freq(t) (3)

In Non-patent Literature 1, the explanation is given about unit-ness as an important attribute that a term should have. Herein, the unit-ness represents the degree of stable use of a particular linguistic unit (such as a word constituting a compound word, or a compound word) in a text collection. That is based on the hypothesis that a term having a high degree of unit-ness often represents the fundamental notion of the concerned text collection. According to the first embodiment, a sentence that includes a large number of important terms having a high degree of unit-ness becomes selectable as a key sentence. Meanwhile, in the compound-word-based extraction method, the amount of calculation is “(number of written documents)×(number of words in each written document)”. Hence, for example, as compared to the method of calculating the degree of similarity among related terms or sentences, key sentences become selectable at a fast rate.

Meanwhile, the method of calculating the degree of importance of a word or a compound word is not limited to the method described above. Alternatively, for example, it is possible to implement some other degree-of-importance calculation method that is based on the occurrence frequencies of words and the occurrence frequencies of compound words, for example.

Given below is the explanation of a specific example of the operation of calculating the scores LR and FLR. In the target set of sentences for processing, regarding the appearance count of words and compound words, the following cases are considered.
“media/intelligence” (made of words “media” and “intelligence”): appears once
“media/intelligence/technology” (made of words “media”, “intelligence”, and “technology”): appears thrice
“media/processing” (made of words “media” and “processing”): appears twice
“technology/innovation” (made of words “technology” and “innovation”): appears once

The score LR of “media/intelligence/technology” is calculated according to the geometric mean of the left-side concatenation frequency and the right-side concatenation frequency of the words “media”, “intelligence”, and “technology”. Regarding the word “media”, the connection to left-side words occurs for zero number of times, and the connection to right-side words occurs for four times to the word “intelligence” and occurs for two times to the word “processing”, that is, occurs for six times in all. Regarding the word “intelligence”, the connection to left-side words occurs for four times to the word “media”, and the connection to right-side words occurs for three times to the word “technology”. Regarding the word “technology”, the connection to left-side words occurs for three times to the word “intelligence”, and the connection to right-side words occurs once to the word “innovation”.

Thus, according to Equation (1), the score LR is calculated in the following manner.

$$LR ( media intelligence technology ) = ( FL ( media ) + 1 ) \times ( FR ( media ) + 1 ) \times ( FL ( intelligence ) + 1 ) \times ( FR ( intelligence ) + 1 ) \times ( FL ( technology ) + 1 ) \times ( FR ( technology ) + 1 ) = {( ( 0 + 1 ) \times ( 6 + 1 ) \times ( 4 + 1 ) \times ( 3 + 1 ) \times ( 3 + 1 ) \times ( 1 + 1 ) )}^{⋀} ( 1 / 6 ) = 2.87$$

Subsequently, since “media intelligence technology” has the frequency of independent appearance to be equal to three, the score FLR is calculated from Equation (2) as given below.

$$FLR ( media intelligence technology ) = LR ( media intelligence technology ) \times freq ( media intelligence technology ) = ( log ( 2.87 ) + 1 ) \times 3 = 6.16$$

In the case of using Equation (3), the score FLR is calculated in the following manner.

$$FLR ( media intelligence technology ) = LR ( media intelligence technology ) \times freq ( media intelligence technology ) = 2.87 \times 3 = 8.61$$

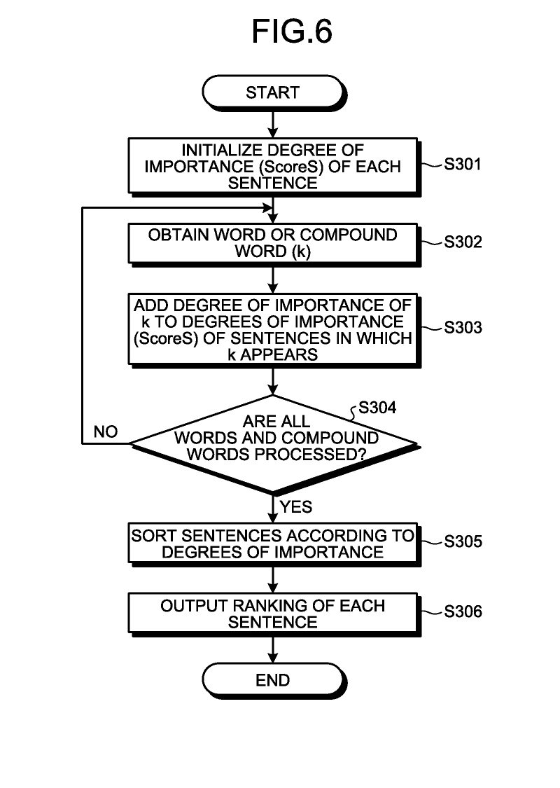

Given below is the detailed explanation of the degree-of-importance calculation operation performed at Step S105. FIG. 6 is a flowchart for explaining an example of the degree-of-importance calculation operation performed according to the first embodiment.

The calculating unit 103 initializes the score (ScoreS) indicating the degree of importance of the sentence (Step S301). Herein, the score ScoreS is obtained for each sentence. In the following explanation, for example, ScoreS(Id) represents the score of a sentence having the identification information “Id”. The calculating unit 103 repeatedly performs the following operations with respect to the words and the compound words extracted at Step S102 illustrated in FIG. 3.

The calculating unit 103 obtains an unprocessed word or an unprocessed compound word (hereinafter, referred to as “k”) (Step S302). Regarding all sentences (having the identification information “Id”) in which k appears, the calculating unit 103 adds the degree of importance of k to the ScoreS(Id) (Step S303). Then, the calculating unit 103 determines whether or not all words and all compound words have been processed (Step S304).

If all words and all compound words are not yet processed (No at Step S304), then the calculating unit 103 obtains the next unprocessed word or the next unprocessed compound word and repeats the subsequent operations. When all words and all compound words are processed (Yes at Step S304), the calculating unit 103 sorts the sentences according to the scores ScoreS (Step S305). According to the sorting result, the calculating unit 103 returns the ranking of the sentences (Step S306). Meanwhile, the calculating unit 103 can set the scores ScoreS themselves as the degrees of importance of the sentences, or can set the ranking sorted according to the scores ScoreS as the degrees of importance of the sentences.

Given below is the explanation of a specific example of calculating the degree of importance of a sentence. Herein, the explanation is given for an example of calculating the degree of importance of the following example sentence: “The/company A/has/done/research/on/the/media intelligence/technology/over/the/years/”. In this sentence, the degree of importance is calculated for the compound word “media intelligence technology” and for the words “company A”, “years”, and “research”. Assume that the following degrees of importance are calculated.
“company A”: 3.0
“media intelligence technology”: 6.16
“years”: 1.0
“research”: 3.0

In this case, the degree of importance of the sentence is calculated to be equal to 3.0+6.16+1.0+3.0=13.16. In this way, from among the words and the compound words included in the example sentence given above, the target terms for calculating the degrees of importance are “company A”, “media intelligence technology”, “years”, and “research”. In the first embodiment, instead of using the degrees of importance calculated for the words “media”, “intelligence”, and “technology” that constitute “media intelligence technology”, the degree of importance calculated for the compound word “media intelligence technology” is added to the degree of importance of the sentence. For all sentences, the degrees of importance are calculated in the same manner. Subsequently, the calculating unit 103 sorts the sentences in order of degree of importance, and returns the ranking result (rank) of each sentence.

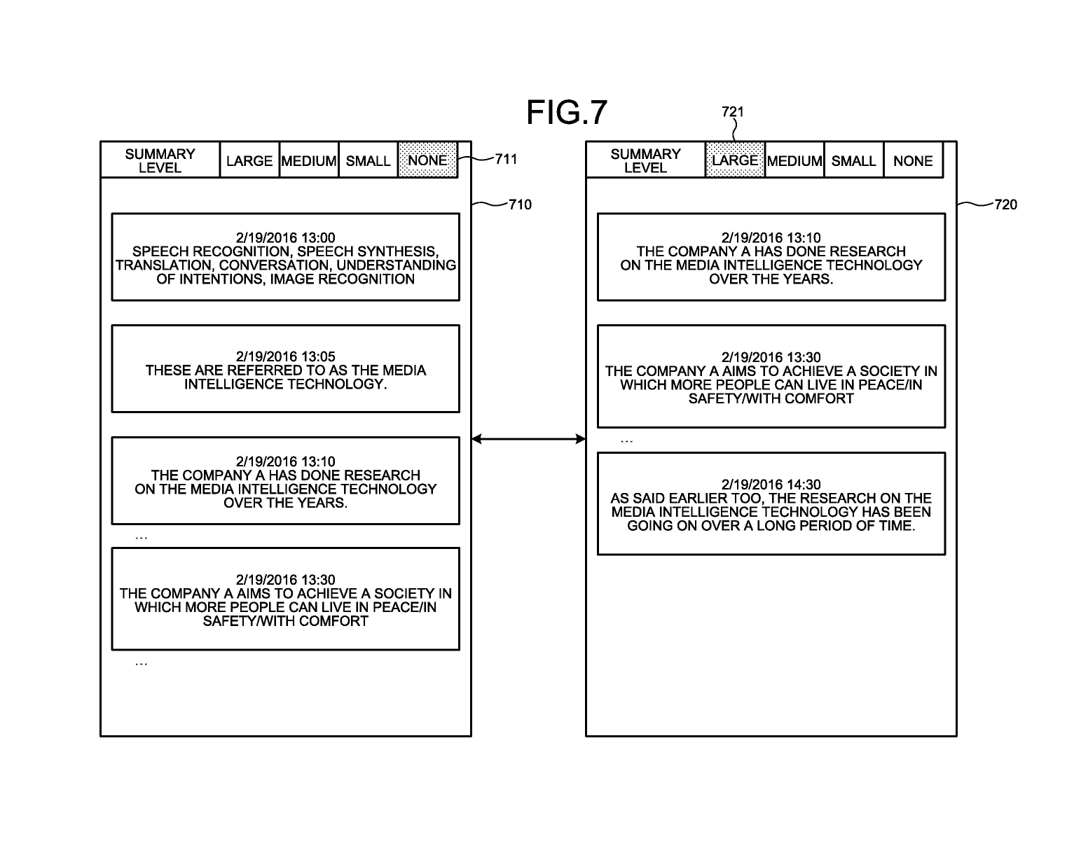

Given below is the explanation of an example of an output operation for outputting key sentences according to the first embodiment. FIG. 7 is a diagram illustrating an example of the output operation for outputting key sentences.

In FIG. 7 is illustrated an example in which key sentences are displayed according to the calculated ranking result and the summary level. Herein, the summary level can be selected from among “large”, “medium”, “small”, and “none”, for example. A display screen 710 represents an exemplary screen for the case in which “none” 711 is selected as the summary level. A display screen 720 represents an exemplary screen for the case in which “large” 721 is selected as the summary level.

When the summary level “none” is selected, all of the target sentences for selection are displayed. When one of the summary levels “large”, “medium”, and “small” is selected, the upper y number of key sentences are displayed from among the target sentences for processing. Herein, for example, “y” is obtained from the ratio (summary percentage) corresponding to the summary level. For example, assume that the summary level “large” has the summary percentage of 10%, the summary level “medium” has the summary percentage of 30%, and the summary level “small” has the summary percentage of 50%. If the number of target sentences for processing is 30 and if the summary level “large” is selected, then the upper three (30×10%) sentences in the ranking are selected as the key sentences and are displayed on the screen. Herein, the selection of the key sentences can be performed using the information processing device 100 (for example, the calculating unit 103), or can be performed using the terminal 200 (for example, the display control unit 202).

As described above, according to the first embodiment, the user can understand the brief overview of a set of sentences in a short amount of time without having to check all of the sentences. Moreover, the degrees of importance of words and compound words are calculated based on the concept called the unit-ness of words constituting compound words, and the degrees of importance of the sentences are calculated according to the degrees of importance of words and compound words. That enables selection of key sentences with a higher degree of accuracy.

### Second Embodiment

Particularly in a set of sentences recognized from speeches, there are times when interjections are included in the sentences. The interjections are not the terms indicating the brief overview of the sentences, and often need not be taken into account while calculating the degrees of importance of the sentences. An information processing device according to a second embodiment converts particular character strings such as interjections into different character strings, and calculates the degrees of importance of the sentences included in the set of sentences that has been subjected to such conversion. That enables calculation of the degrees of importance of the sentences with a higher degree of accuracy.

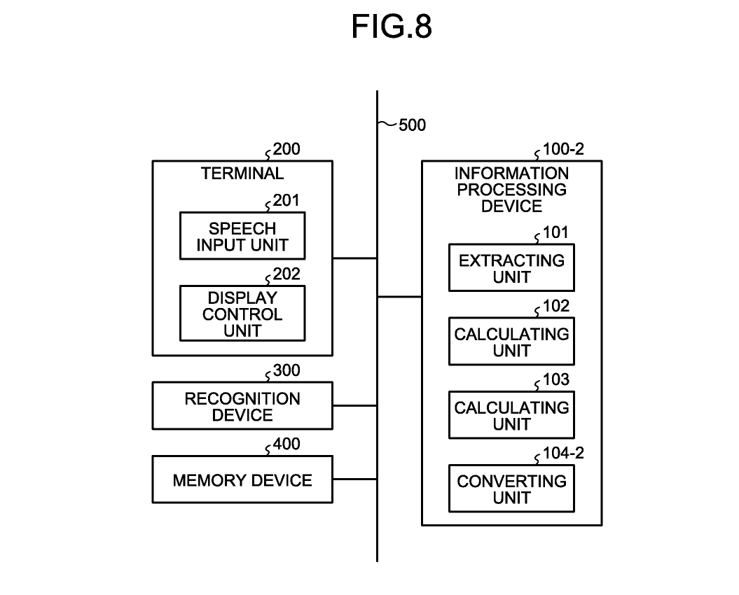

FIG. 8 is a block diagram illustrating an exemplary functional configuration of a system including the information processing device according to the second embodiment. In the system according to the second embodiment; an information processing device 100-2, the terminal 200, the recognition device 300, and the memory device 400 are connected to each other via the network 500. Other than the information processing device 100-2, the other devices have an identical configuration to the configuration according to the first embodiment. Hence, the same reference numerals are used, and the explanation is not repeated.

The information processing device 100-2 includes a converting unit 104-2 in addition to including the constituent elements illustrated in FIG. 1. Regarding each sentence included in a set of sentences, the converting unit 104-2 converts particular character strings (first character strings) included in that sentences into different character strings (second character strings). For example, the converting unit 104-2 converts the notation of the sentence, which is included in the text data stored in the memory device 400, into a different notation using filler conversion rules.

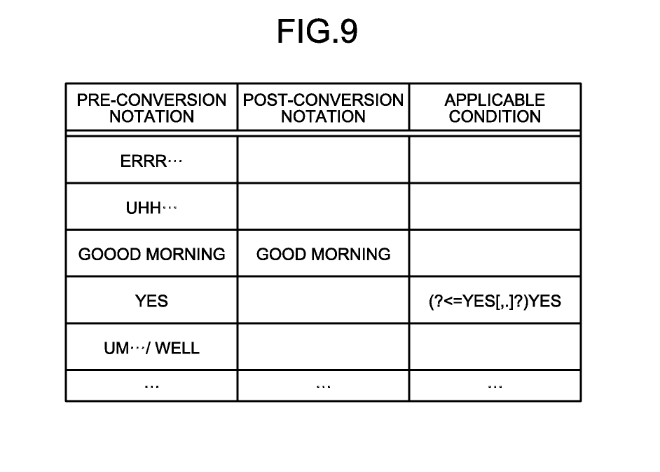

The filler conversion rules are meant for converting a particular character string (filler), from among character strings, into a different character string. The filler conversion rules can be stored in a memory unit inside the information processing device 100-2 or can be stored in an external device such as the memory device 400. FIG. 9 is a diagram illustrating an exemplary data structure of the filler conversion rules.

As illustrated in FIG. 9, the filler conversion rules include pre-conversion notations, post-conversion notations, and applicable conditions. If a morpheme matching with a pre-conversion notation is present in the text data illustrated in FIG. 2, for example; then the converting unit 104-2 converts the notation of the morpheme into a post-conversion notation. When there is nothing written in the post-conversion notation, the pre-conversion notation is converted into a null character. In the example illustrated in FIG. 9, notations such as “errr . . . ”, “uhh . . . ”, “yes”, and “um . . . /well” are converted into null characters. Moreover, a plurality of morphemes such as “um . . . /well” can also be considered for conversion.

An applicable condition is a condition for narrowing down the target to which a filler conversion rule is to be applied. Although the applicable conditions can be written using an arbitrary method, it is possible to write them in, for example, regular expression as illustrated in FIG. 9. When the applicable condition is not written, the narrowing down of the target is not done. In the example of the pre-conversion notation “yes”, the applicable condition is “(?<=yes[, .]?) yes”. This applicable condition is an example in which morphemes such as “yes. yes” and “yes yes” are narrowed down as targets, and one of the “yes” is converted into a null character.

The conversion operation performed by the converting unit 104-2 is not limited to the method of using the filler conversion rules. Alternatively, for example, a method can be implemented in which the part of speech of the morphemes that are obtained during morphological analysis is referred to, and such morphemes are deleted (converted to null characters) which have a particular part of speech (for example, interjections). Moreover, the extracting unit 101 can extract compound words and words (first words) other than the words constituting the compound words from the sentences included in the set of sentences that has been subjected to the conversion of character strings by the converting unit 104-2.

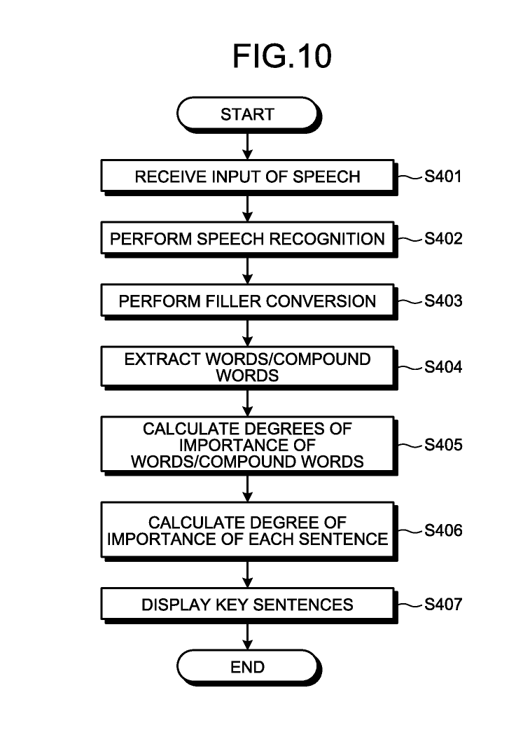

Explained below with reference to FIG. 10 is a degree-of-importance display operation performed by the information processing device 100-2 configured in the abovementioned manner according to the second embodiment. FIG. 10 is a flowchart for explaining an example of the degree-of-importance display operation performed according to the second embodiment.

The operations performed at Step S401, Step S402, and Steps S404 to S407 are identical to the operations performed at Steps S101 to S106 by the information processing device 100 according to the first embodiment. Hence, that explanation is not repeated.

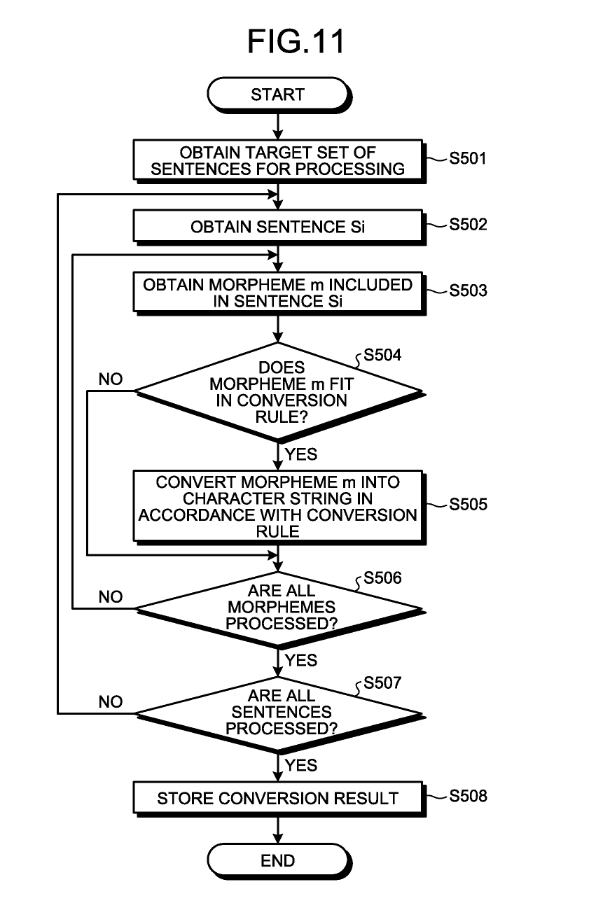

In the second embodiment, before extracting words/compound words, the converting unit 104-2 performs a filler conversion operation (Step S403). The details of the filler conversion operation are given below with reference to FIG. 11. Herein, FIG. 11 is a flowchart for explaining an example of the filler conversion operation.

The converting unit 104-2 obtains the set of sentences from which key sentences are to be selected (Step S501). Then, the converting unit 104-2 obtains an unprocessed sentence Si (where i is an integer equal to or greater than one but equal to or smaller than the number of sentences) (Step S502). Subsequently, the converting unit 104-2 obtains an unprocessed morpheme m in the obtained sentence Si (Step S503).

Then, the converting unit 104-2 determines whether or not the obtained morpheme m fits in any of the filler conversion rules (Step S504). For example, the converting unit 104-2 determines whether or not the morpheme m matches with any “pre-conversion notation” included in the filler conversion rules illustrated in FIG. 9. If there is a matching “pre-conversion notation”, then the converting unit 104-2 determines whether or not the morpheme m satisfies the applicable condition corresponding to that “pre-conversion notation”. Herein, the determination not only includes the determination of whether or not a single morpheme matches with a rule but also includes the determination of whether or not matching with a rule by a single morpheme occurs in succession and whether or not a plurality of morphemes matches with a rule. As a result, for example, even if a “pre-conversion notation” includes a plurality of morphemes, it becomes possible to perform determination in an appropriate manner.

If the obtained morpheme m fits in any of the filler conversion rules (Yes at Step S504), then the converting unit 104-2 converts the morpheme m into a post-conversion character string set in the matching filler conversion rule (for example, into a “post-conversion notation” illustrated in FIG. 9) (Step S505). However, if the obtained morpheme m does not fit in any of the filler conversion rules (No at Step S504), the converting unit 104-2 determines whether or not all morphemes have been processed (Step S506).

If all morphemes are not yet processed (No at Step S506), the system control returns to Step S503, and the converting unit 104-2 obtains the next morpheme and repeats the subsequent operations. When all morphemes are processed (Yes at Step S506), the converting unit 104-2 determines whether or not all sentences have been processed (Step S507). If all sentences are not yet processed (No at Step S507), then the system control returns to Step S502, and the converting unit 104-2 obtains the next sentence and repeats the subsequent operations.

When all sentences are processed (Yes at Step S507), the converting unit 104-2 stores the conversion result in the memory device 400 (Step S508). For example, in the item “morpheme” included in the text data illustrated in FIG. 2, the converting unit 104-2 substitutes the concerned morphemes with the post-conversion morphemes. Meanwhile, the method of storing the conversion result is not limited to the method explained herein. Alternatively, for example, instead of substituting the morphemes in the item “morpheme”, the sentences including the conversion result (i.e., converted sentences) can be held as a separate item.

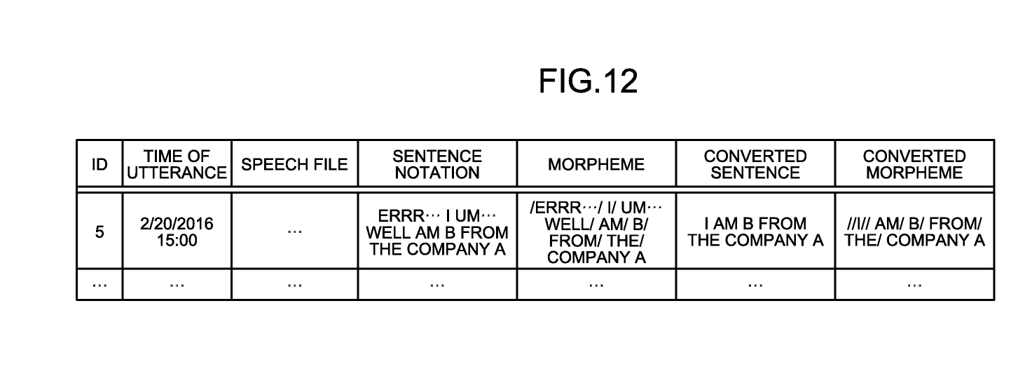

FIG. 12 is a diagram illustrating another example of the sentences (text data) stored in the memory device 400. FIG.12 is an example of the text data that contains converted sentences as a separate item. As compared to the text data illustrated in FIG. 2, the following two items are added: an item “converted sentence” of the converted items obtained as the result of performing the filler conversion operation; and an item “converted morpheme” of the morphemes included in the converted sentences. In the items “converted sentence” and “converted morpheme”, the filler conversion result is stored at Step S508 illustrated in FIG. 11. In the example illustrated in FIG. 12, regarding a sentence “errr . . . I um . . . well am B from the company A”, a converted sentence from which “errr . . . ” and “um . . . well” are removed is stored along with the converted morphemes. As a result, while displaying the key sentences, no unnecessary character strings are displayed, thereby making it easier for the user to understand the brief overview of the sentences.

### Third embodiment

An information processing device according to a third embodiment calculates the degrees of importance of the sentences by taking into account the similarity among the sentences. As a result, for example, a sentence similar to an entire set of sentences becomes selectable as a key sentence. Moreover, regarding a sentence similar to an already-selected sentence that is already selected as a similar sentence, the concerned sentence is difficult to get selected. That enables resolution of the redundancy issue in which a plurality of mutually similar sentences is selected as the key sentences.

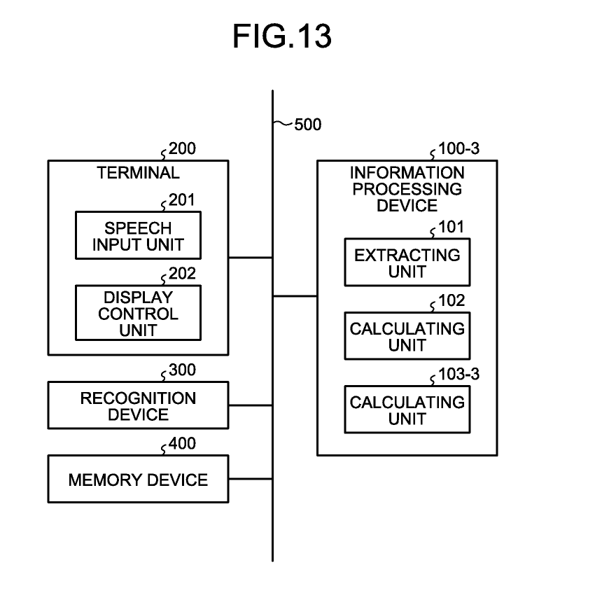

FIG. 13 is a block diagram illustrating an exemplary functional configuration of a system including the information processing device according to the third embodiment. In the system according to the third embodiment; an information processing device 100-3, the terminal 200, the recognition device 300, and the memory device 400 are connected to each other via the network 500. Other than the information processing device 100-3, the other devices have an identical configuration to the configuration according to the first embodiment. Hence, the same reference numerals are used, and the explanation is not repeated. In the information processing device 100-3, the functions of a calculating unit 103-3 are different than the functions of the calculating unit 103 according to the first embodiment.

The calculating unit 103-3 calculates the degree of importance (ScoreS) of a sentence as explained in the first embodiment as well as calculates the degree of importance of the sentence by taking into account the similarity among the sentences, and calculates the final degree of importance of the sentence from those two types of the degree of importance. For example, based on the degrees of importance of the words and the compound words as calculated by the calculating unit 102, the calculating unit 103-3 calculates a score (a first score) indicating the degree of importance of the sentence. This score is calculated in an identical manner to the calculation of the degree of importance of a sentence according to the first embodiment.

Moreover, with respect to a sentence included in a set of sentences, the calculating unit 103-3 calculates a score (a second score) that indicates the degree of importance of the sentence in such a way that, the degree of importance of the concerned sentence is higher in proportion to the similarity of the concerned sentence with the set of sentences, and, if there is an already-selected sentence similar to the set of sentences, the degree of importance of the concerned sentence is higher in inverse proportion to the similarity of the concerned sentence with the already-selected sentence. This score is used for making it difficult to select similar sentences. Then, based on the second score, the calculating unit 103-3 calculates the final degree of importance of the sentence.

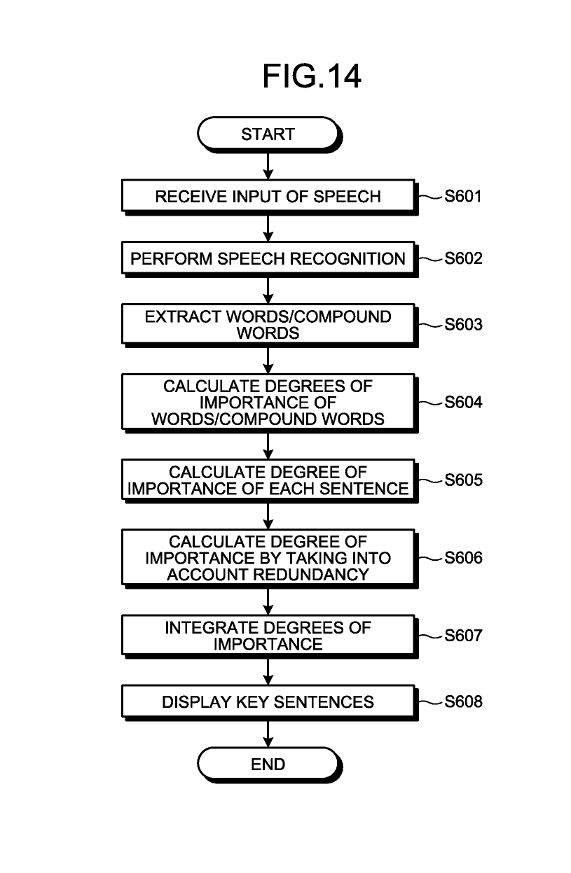

Explained below with reference to FIG. 14 is a degree-of-importance display operation performed by the information processing device 100-3 configured in the abovementioned manner according to the third embodiment. FIG. 14 is a flowchart for explaining an example of the degree-of-importance display operation performed according to the third embodiment.

The operations performed at Steps S601 to S605 and Step S608 are identical to the operations performed at Steps S101 to S106 by the information processing device 100 according to the first embodiment. Hence, that explanation is not repeated.

The calculating unit 103-3 calculates the degree of importance (the first score) of each sentence according to an identical method to the first embodiment (Step S605), and then calculates the degree of importance (the second score) of each score by taking into account the redundancy (Step S606). Subsequently, the calculating unit 103-3 integrates the two types of the degree of importance and calculates the final degree of importance (Step S607).

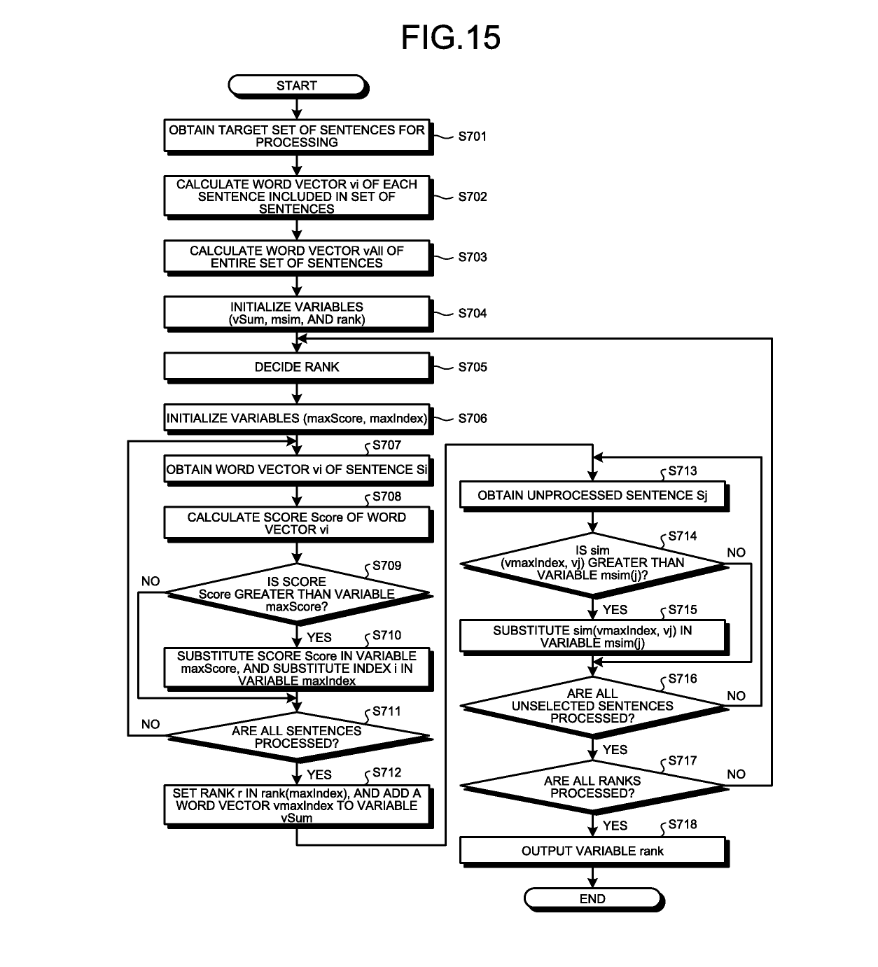

FIG. 15 is a flowchart for explaining an example of the calculation operation performed at Step S606. Firstly, the calculating unit 103-3 obtains the set of sentences from which key sentences are to be selected (Step S701). Then, regarding each sentence Si included in the set of sentence, the calculating unit 103-3 calculates a word vector vi (Step S702). Herein, the sentence Si represents the i-th sentence included in the set of sentences (where i is an integer equal to or greater than one but equal to or smaller than the number of sentences). Moreover, the vector vi represents the word vector of the sentence Si. Subsequently, the calculating unit 103-3 calculates a word vector vAll of the entire set of sentences (Step S703).

A word vector is, for example, a vector having the weights of the words included either in a sentence or a set of sentences as the elements. Herein, the weight can be any type of value. For example, it is possible to use the term frequency-inverse document frequency (tf-idf) as given below in Equations (4) and (5).

tf(t)×idf(t) (4)

idf(t)=log(D/df(t))+1 (5)

Herein, tf(t) represents the occurrence frequency of a word t in the sentences. In Equation (5), D represents the number of sentences, and df(t) represents the number of written documents in which the word t in the set of sentences appears. Regarding the word vector vAll of the set of sentences, the weight is calculated as the average value of the weights of the word vector vi of each sentence with respect to the same words.

After calculating the word vectors, the calculating unit 103-3 initializes the variables (vSum, msim, and rank) used in the calculation operation (Step S704). The variable vSum represents a set vector of the already-selected key sentences. The variable msim (j) represents the degree of similarity between an unselected sentence Sj and the already-selected key sentences. The variable rank (i) represents a variable for holding the rank of the i-th sentence Si.

The calculating unit 103-3 decides an unprocessed rank (r) (Step S705). For example, the calculating unit 103-3 decides the target ranks for processing in order from the topmost rank (for example, r=1) to the bottommost rank.

Herein, the bottommost rank can be set, for example, to be equal to the number of sentences in the set of sentences. That makes it possible to decide the ranks (the degrees of importance) of all sentences in the set of sentences.

The calculating unit 103-3 initializes the variables (maxScore and maxIndex) to be used in the following operations (Step S706). The variable maxScore represents the maximum score of sentences. The variable maxIndex represents the index of the sentence that has the maximum score. Herein, the index indicates the number at which the concerned sentence is present in the set of sentences.

Regarding the current rank, the calculating unit 103-3 repeatedly performs the operations from Steps S707 to S711 for the number of times equal to the number of sentences. Firstly, the calculating unit 103-3 obtains the word vector vi of the unprocessed sentence Si (Step S707). Then, the calculating unit 103-3 calculates the score (“Score”) of the word vector Si (Step S708).

The calculating unit 103-3 calculates the score “Score” of the word vector vi according to, for example, Equation (6) given below.

Score=λ1×sim(vi, vAll)

−(1−λ1)×(λ2×sim(vi, vSum)+(1−λ2)×msim(i)) (6)

Herein, λ1 and λ2 are constant numbers equal to or greater than zero but equal to or smaller than one. Moreover, sim represents the degree of similarity (for example, the cosine distance) of each vector. Given below is the explanation of the meaning of each equation.

Herein, sim(vi, vAll) represents the degree of similarity of the vector vAll of the entire set of sentences with the vector vi of the sentence Si. That is, the magnitude of sim(vi, vAll) represents the degree of similarity between a single sentence and the entire text. Thus, a sentence having a high degree of similarity is believed to be a sentence expressing the contents of the entire text.

Moreover, sim(vi, vSum) represents the degree of similarity of the set vSum of already-selected sentences with the vector vi of the sentence Si. Due to the constant term “−(1−λ1)×λ2” present prior to this numerical expression, when the degree of similarity is high, the score “Score” becomes a low value. That is, a sentence similar to the set of already-selected sentences becomes difficult to get selected.

Furthermore, msim(i) represents the degree of similarity between each already-selected sentence and the vector vi of the sentence Vi. Due to the constant term “−(1−λ1)×(1−λ2)” present prior to this numerical expression, when the degree of similarity is high, the score “Score” becomes a low value. That is, a sentence similar to an already-selected sentence becomes difficult to get selected. As a result of taking into account not only the degree of similarity sim(vi, vSum) but also the degree of similarity msim(i), for example, in the case in which the degree of similarity is not high when compared with all already-selected sentences (the set of already-selected sentences) but there are sentences similar to individual already-selected sentences, it becomes possible to appropriately eliminate the similar sentences.

Returning to the explanation with reference to FIG. 15, the calculating unit 103-3 determines whether or not the score (“Score”) calculated at Step S708 is greater than the variable maxScore (Step S709). If the score (“Score”) is greater than the variable maxScore (Yes at Step S709), then the calculating unit 103-3 substitutes the calculated score in the variable maxScore and substitutes the suffix “i” of the vector vi in the variable maxIndex (Step S710). On the other hand, if the score (“Score”) is not greater than the variable maxScore (No at Step S709), the calculating unit 103-3 determines whether or not all sentences have been processed (Step S711). If all sentences are not yet processed (No at Step S711), then the system control returns to Step S707, and calculating unit 103-3 selects the next sentence and repeats the subsequent operations.

When all sentences are processed (Yes at Step S711), the calculating unit 103-3 substitutes “r” in the rank (maxIndex) and adds a word vector vmaxIndex to the variable vSum (Step S712). The word vector vmaxIndex represents the word vector of the sentence having the variable maxIndex as the index. In an identical manner to vAll, the average value of the weights with respect to the same words represents the weight of the word vector added to the variable vSum.

The calculating unit 103-3 obtains an unprocessed sentence Sj from among the unselected sentences (where j is an integer equal to or greater than one but equal to or smaller than the number of unprocessed sentences) (Step S713). Then, the calculating unit 103-3 determines whether or not the word vector vmaxIndex of the sentence selected corresponding to the current rank and the word vector vj of the unselected sentence Sj have the degree of similarity to be greater than the variable msim(j) (Step S714).

If the degree of similarity is greater than the variable msim(j) (Yes at Step S714), then the calculating unit 103-3 substitutes the degree of similarity between the word vector vmaxIndex and word vector vj in the variable msim(j) (Step S715). As a result of performing the operations from Steps S713 to S715, the degree of similarity between the selected sentences and an unselected sentence is calculated and is used in the score calculation at Step S708 performed later.

After the operation at Step S715 is performed or if the degree of similarity between the word vector vmaxIndex and the word vector vj is not greater than the variable msim(j) (No at Step S714), the calculating unit 103-3 determines whether or not all unselected sentences have been processed (Step S716). If all unselected sentences are not yet processed (No at Step S716), then the system control returns to Step S713, and the calculating unit 103-3 repeats the operations. When all unselected sentences are processed (Yes at Step S716), the calculating unit 103-3 determines whether or not all ranks have been processed (Step S717). If all ranks are not yet processed (No at Step S717), the system control returns to Step S705, and the calculating unit 103-3 again selects the sentence having the next rank.

When all ranks are processed (Yes at Step S717), the calculating unit 103-3 returns the variable “rank” (Step S718). It marks the end of the operations.

As described above, the variable “rank” holds the rank, that is, the degree of importance of each sentence. The variable “rank” is equivalent to the score (the second score) that indicates the degree of importance of the sentence in such a way that, the degree of importance of the concerned sentence is higher in proportion to the similarity of the concerned sentence with the set of sentences, and, if there is a sentence that has already been selected as a sentence similar to the set of sentences, the degree of importance of the concerned sentence is higher in inverse proportion to the similarity of the concerned sentence with the already-selected sentence.

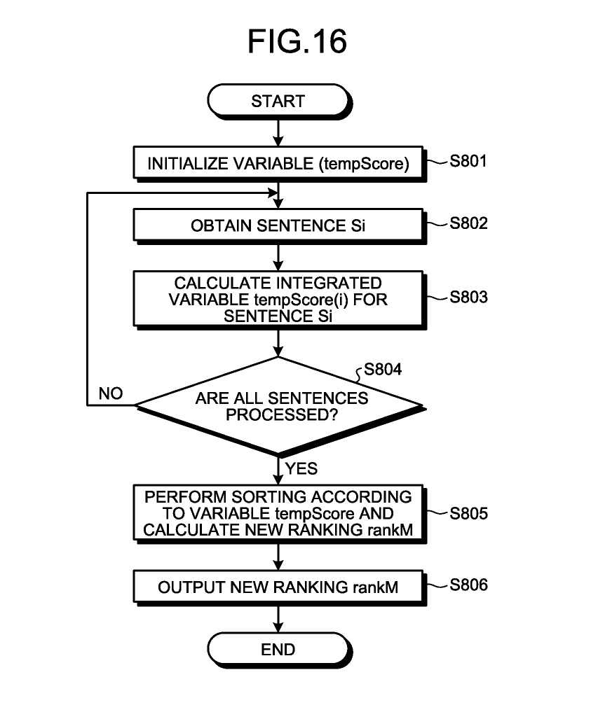

FIG. 16 is a flowchart for explaining an example of the calculation operation performed at Step S607. The calculation operation performed at Step S607 is performed to calculate the final degree of importance by integrating the scores calculated at Steps S605 and S606. In the following explanation, the score calculated at Step S605 is referred to as rank1(i), and the score calculated at Step S606 is referred to as rank2(i). The scores rank1(i) and rank2(i) indicate the scores (ranks) of the i-th sentence.

The calculating unit 103-3 initializes a score tempScore that holds the score (the degree of importance) of each sentence (Step S801). The calculating unit 103-3 obtains an unprocessed sentence Si (Step S802). Then, for the sentence Si, the calculating unit 103-3 calculates the score tempScore(i) by integrating the scores rankl (i) and rank2 (i) (Step S803). The score tempScore (i) represents the score of the i-th sentence Si. The calculating unit 103-3 calculates the score tempScore (i) according to, for example, Equation (7) given below. Herein, αis a constant number equal to or greater than zero but equal to or smaller than one.

tempScore (i)=α×rank1(i)+(1−α)rank2(i) (7)

Subsequently, the calculating unit 103-3 determines whether or not all sentences have been processed (Step S804). If all sentences are not yet processed (No at Step S804), the system control returns to Step S802, and the calculating unit 103-3 obtains the next sentence and repeats the subsequent operations.

When all sentences are processed (Yes at Step S804), the calculating unit 103-3 sorts the sentences according to the value of the variable tempScore, and calculates rankM indicating the new ranking (Step S805). Then, the calculating unit 103-3 outputs rankM as the final degrees of importance of the sentences (Step S806). It marks the end of the operations.

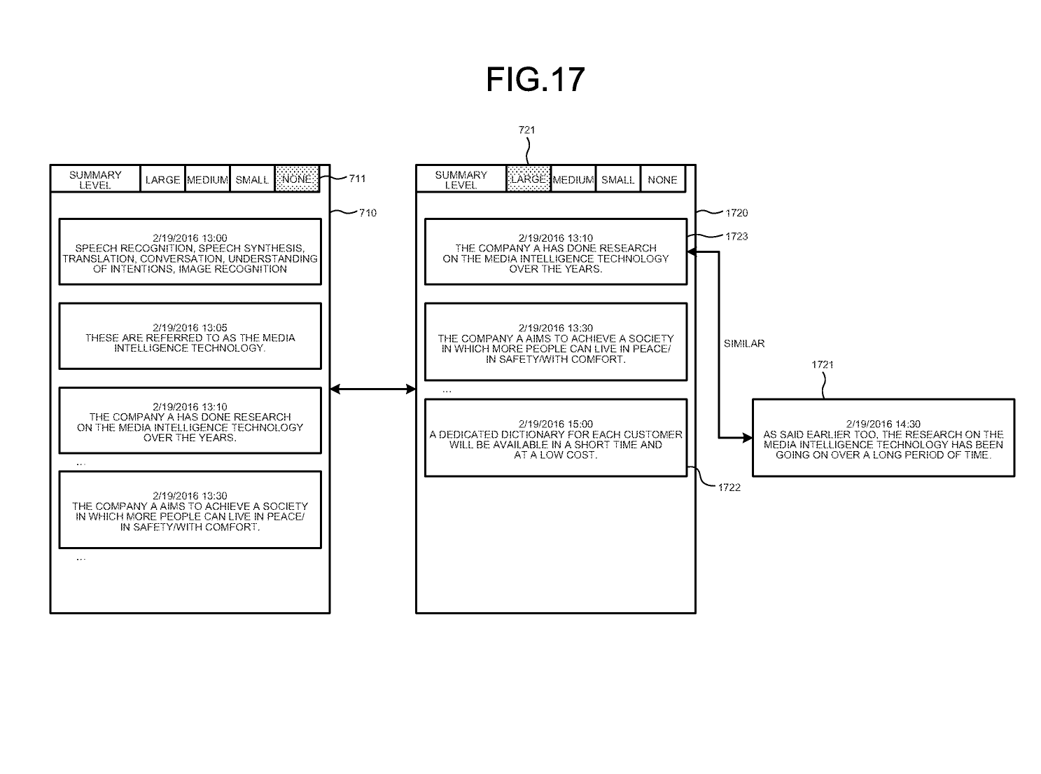

Given below is the explanation of an example of the output operation for outputting key sentences according to the third embodiment. FIG. 17 is a diagram illustrating an example of the output operation for outputting key sentences. On a display screen 1720 according to the third embodiment, a sentence 1721 (“As said earlier too, the research on the media intelligence technology has been going on over a long period of time.”) is not displayed, and a sentence 1722 is displayed instead. That is because, the sentence 1721 is similar to a sentence 1723 (“The company A has done research on the media intelligence technology over the years.”), which is the topmost sentence; and thus has a lower rank.

### MODIFICATION EXAMPLE

As a result of the operations performed according to the third embodiment, the degrees of importance of the sentences can be calculated by taking into account the degrees of importance (the unit-ness) of the compound words and the degrees of similarity (redundancy) among the sentences. However, the method of calculating the degrees of importance of the sentences by taking into account the unit-ness and the redundancy is not limited to the method mentioned above. Alternatively, for example, the configuration can be such that the degrees of importance of the words and the compound words as calculated by the calculating unit 102 are used as the weights of word vectors, and the operations illustrated in FIG. 15 are performed. That is, instead of using tf-idf representing the weight at Step S703 illustrated in FIG. 15, the degree of importance calculated by the calculating unit 102 can be used, and the operations illustrated in FIG. 15 can be performed. As a result, the degrees of importance of the sentences can be calculated by taking into account the weights (unit-ness) of the words constituting compound words and by taking into account the redundancy representing the degree of similarity among the sentences. In that case, for example, the operations at Steps S605 and S607 illustrated in FIG. 14 may be skipped. During the operation (FIG. 15) equivalent to the operation at Step S606 illustrated in FIG. 14, instead of using tf-idf as described earlier, the degree of importance calculated by the calculating unit 102 can be used.

### Fourth Embodiment

An information processing device according to a fourth embodiment calculates the degrees of importance by also taking into account the concatenation frequencies calculated from a large-scale text corpus. As a result, for example, even if there are only a small number of written documents from which key sentences are to be selected, the degrees of importance can be calculated with a higher degree of accuracy. In this way, the concatenation frequency either can be the frequency at which a word constituting a compound word gets connected with other words included in the set of sentences from which the compound word is extracted, or can be the frequency at which a word constituting a compound word gets connected with other words included in a corpus different than the set of sentences from which the compound word is extracted.

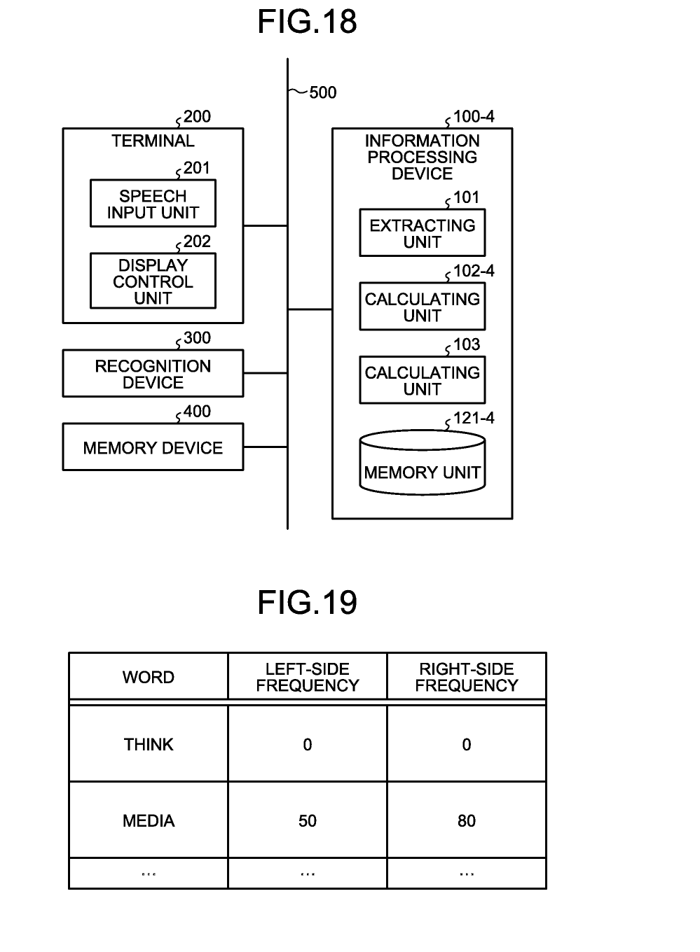

FIG. 18 is a block diagram illustrating an exemplary functional configuration of a system including the information processing device according to the fourth embodiment. In the system according to the second embodiment; an information processing device 100-4, the terminal 200, the recognition device 300, and the memory device 400 are connected to each other via the network 500. Other than the information processing device 100-4, the other devices have an identical configuration to the configuration according to the first embodiment. Hence, the same reference numerals are used, and the explanation is not repeated. In the information processing device 100-4, the functions of a calculating unit 102-4 are different than the functions of the calculating unit 102 according to the first embodiment, and a memory unit 121-4 is newly added.

The memory unit 121-4 is used to store a dictionary that holds the left-side concatenation frequencies and the right-side concatenation frequencies calculated from a large-scale text corpus with respect to the words constituting compound words. Herein, the large-scale text corpus either can be a text corpus of every field without taking into account the type of domain, or can be a text corpus of the same field as the field of the target key sentences for selection. The dictionary is calculated in advance using such a text corpus. Meanwhile, instead of storing the dictionary in the memory unit 121-4 in the information processing device 100-4, it can be stored in an external device such as the memory device 400, for example.

FIG. 19 is a diagram illustrating an exemplary data structure of the dictionary. As illustrated in FIG. 19, the dictionary includes the items “word”, “left-side frequency”, and “right-side frequency”. In this example, the word “think” has the left-side concatenation frequency as well as the right-side concatenation frequency to be equal to zero. The word “media” has the left-side concatenation frequency to be equal to 50 and has the right-side concatenation frequency to be equal to 80.

As compared to the calculating unit 102 according to the first embodiment, the calculating unit 102-4 differs in the way that, while calculating the degrees of importance (first degrees of importance) of words and compound words, the concatenation frequencies held in the dictionary are also referred to.

For example, at Step S215 of the extraction/calculation operation illustrated in FIG. 5, the calculating unit 102 according to the first embodiment calculates the scores LR and FLR using the variables countL and countR. In contrast, the calculating unit 102-4 according to the fourth embodiment adds the left-side concatenation frequencies (left-side frequencies) and the right-side concatenation frequencies (right-side frequencies) of the words as obtained from dictionary to the variables countL and countR, respectively, and then calculates the scores LR and FLR. Alternatively, instead of using the scores countL and countR, the calculating unit 102-4 can take into account only the left-side frequencies and the right-side frequencies obtained from the dictionary, and then calculate the scores LR and FLR.

As a result, not only it becomes possible to take into account the set of sentences from which key sentences are to be selected, but it also becomes possible to take into account the degrees of importance based on a large-scale text corpus. That is, it becomes possible to calculate more accurate degrees of importance by taking into account the manner in which the words are used in the world.

Meanwhile, since the flow of other operations is identical to the flow explained with reference to FIG. 5, the detailed explanation is not repeated. Moreover, the overall flow of the degree-of-importance display operation according to the fourth embodiment is identical to FIG. 3 in which the degree-of-importance display operation according to the first embodiment is illustrated. Hence, that explanation is not repeated.

As described above, according to the first to fourth embodiments, as a result of taking into account the degrees of importance of compound words, the degrees of importance of the sentences can be calculated with a higher degree of accuracy.

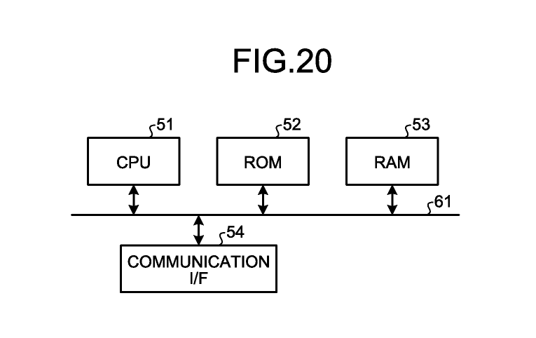

Explained below with reference to FIG. 20 is a hardware configuration of the information processing device according to the first to fourth embodiments. FIG. 20 is an explanatory diagram illustrating an exemplary hardware configuration of the information processing device according to the first to fourth embodiments.

The information processing device according to the first to fourth embodiments includes a control device such as a central processing unit (CPU) 51, memory devices such as a read only memory (ROM) 52 and a random access memory (RAM) 53, a communication interface (I/F) 54 that establishes connection with a network and performs communication, and a bus 61 that connects the constituent elements to each other.

A computer program executed in the information processing device according to the first to fourth embodiments is stored in advance in the ROM 52.

Alternatively, the computer program executed in the information processing device according to the first to fourth embodiments can be recorded as an installable file or an executable file in a computer-readable recording medium such as a compact disk read only memory (CD-ROM), a flexible disk (FD), a compact disk recordable (CD-R), or a digital versatile disk (DVD); and can be provided as a computer program product.

Still alternatively, the computer program executed in the information processing device according to the first to fourth embodiments can be stored in a downloadable manner in a computer connected to a network such as the Internet. Still alternatively, the computer program executed in the information processing device according to the first to fourth embodiments can be distributed over a network such as the Internet.

The computer program executed in the information processing device according to the first to fourth embodiments can make a computer to function as the constituent elements of the information processing device. In that computer, the CPU 51 can read the computer program from a computer-readable memory medium into a main memory device, and can execute the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
an extracting unit that, from a sentence included in a set of sentences, extracts a compound word made of a plurality of words and extracts a first word other than the words constituting the compound word;
a first calculating unit that, based on occurrence frequency of the first word and based on occurrence frequency of the compound word, calculates a first degree of importance indicating degree of importance of the first word and calculates a first degree of importance indicating degree of importance of the compound word; and
a second calculating unit that, with respect to a first sentence included in the set of sentences, calculates a second degree of importance, which indicates degree of importance of the first sentence, based on the first degree of importance of the word and the first degree of importance of the compound word.

2. The information processing device according to claim 1, wherein the first calculating unit calculates the first degree of importance based on occurrence frequency of the first word, based on occurrence frequency of the compound word, and based on concatenation frequency indicating frequency at which a word constituting the compound word gets connected to some other word.

3. The information processing device according to claim 2, wherein the concatenation frequency represents at least one of
frequency at which a word constituting the compound word gets connected to some other word included in the set of sentences, and
frequency at which a word constituting the compound word gets connected to some other word included in a corpus different than the set of sentences.

4. The information processing device according to claim 1, wherein the set of sentences includes a sentence output as a result of speech recognition.

5. The information processing device according to claim 4, further comprising a converting unit that converts a first character string, which is included in a sentence included in the set of sentences, into a second character string, wherein
the extracting unit extracts the compound word and the first word from a sentence which is included in the set of sentences and which includes a character string converted by the converting unit.

6. The information processing device according to claim 1, wherein the second calculating unit
calculates a first score indicating degree of importance of the first sentence based on the first degree of importance of the first word and the first degree of importance of the compound word included in the first sentence,
calculates a second score indicating degree of importance of a sentence included in the set of sentences in such a way that, the degree of importance of the concerned sentence is higher in proportion to the similarity of the concerned sentence with the set of sentences, and, if there is a sentence that has already been selected as a sentence similar to the set of sentences, degree of importance of concerned sentence is higher in inverse proportion to similarity of concerned sentence with the already-selected sentence, and
calculates the second degree of importance based on the first score and the second score.

7. The information processing device according to claim 1, wherein, with respect to a sentence included in the set of sentences, the second calculating unit calculates, using a word vector in which the first degree of importance is treated as weight, the second degree of importance in such a way that, the degree of importance of the concerned sentence is higher in proportion to the similarity of the concerned sentence with the set of sentences, and, if there is a sentence that has already been selected as a sentence similar to the set of sentences, degree of importance of concerned sentence is higher in inverse proportion to similarity of concerned sentence with the already-selected sentence.

8. An information processing method comprising:
extracting, from a sentence included in a set of sentences, a compound word, which is made of a plurality of words, and a first word other than the words constituting the compound word;
first-calculating that, based on occurrence frequency of the first word and based on occurrence frequency of the compound word, includes calculating a first degree of importance indicating degree of importance of the first word and calculating a first degree of importance indicating degree of importance of the compound word; and
second-calculating that, with respect to a first sentence included in the set of sentences, includes calculating a second degree of importance, which indicates degree of importance of the first sentence, based on the first degree of importance of the word and the first degree of importance of the compound word.

9. A computer program product having a computer readable medium including programmed instructions, wherein the instructions, when executed by a computer, cause the computer to function as:
an extracting unit that, from a sentence included in a set of sentences, extracts a compound word made of a plurality of words and extracts a first word other than the words constituting the compound word;
a first calculating unit that, based on occurrence frequency of the first word and based on occurrence frequency of the compound word, calculates a first degree of importance indicating degree of importance of the first word and calculates a first degree of importance indicating degree of importance of the compound word; and
a second calculating unit that, with respect to a first sentence included in the set of sentences, calculates a second degree of importance, which indicates degree of importance of the first sentence, based on the first degree of importance of the word and the first degree of importance of the compound word.
